(19) United States
(12) Patent Application Publication
(10) Pub. No.: US 2008/0136131 A1
(43) Pub. Date: Jun. 12, 2008

(54) TRANSPORTATION DEVICE

(75) Inventors: Viktor Sorg, Salem (DE); Christoph Welte, Uberlingen (DE); Jurgen Stecher, Mariabrunn (DE)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: J. WAGNER GMBH, Markdorf (DE)

(21) Appl. No.: 11/951,463

(22) Filed: Dec. 6, 2007

(30) Foreign Application Priority Data
Dec. 7, 2006 (DE) 102006058075
May 18, 2007 (DE) 102007023366

(51) Int. Cl. B62B 1/26

(52) U.S. Cl. 280/47.18

(57) ABSTRACT

In an undercarriage (1) for transportation of a feeding pump device (3) consisting of a driving motor (4) and a feeding pump (3) intended to feed and/or process fluid media, this feeding pump (3) can be deployed into a supply container (10) and is devised of a supporting frame (11) constructed of hollow profiles (13, 14, 15) which is carrying the feeding device (2), that is equipped with two laterally mounted panels (21 and 22), wherein support or guiding camshafts (23 and 24) mounted opposite from each other are integrated. At least two guiding bolts (31, 32) hook into the support shaft (23, 24). The undercarriage (1) is supported during operations across the horizontal bars over large panels, but still the feeding device (2) will be secured inside the panels (21, 22) of the supporting frame.

The invention concerns an undercarriage for transportation of a device consisting of a driving engine and a feeding pump, which feeds and/or processes fluid media, such as mortar, cement mixtures, etc.; this feeding pump is incorporated into a supply-container designed to hold the medium which is to be processed and is constructed of an L-shaped hollow section and is provided with a supporting frame on carrying wheels.

A feeding device of this kind is similar to DE 195 42 527. This feeding pump, constructed as a screw pump, is mounted on an undercarriage by means of a specially designed clamp, on which the supply-container holding the processed material is attached.

The maintenance cost of the feeding device as well as for the container is fairly considerable. Of particular disadvantage is the fact that changing the container is time-consuming and complicated, because the clamp connection between one of the downstream speed reducers and the bearer frame can be unfastened. In addition, the feeding pump with the speed reducer must be lifted vertically out of the container, before it can be taken of the bearer frame. To exchange the container two people are needed, limiting the action radius of this device in larger construction sites and rendering it more expensive.

The challenge of the invention is therefore, to provide an undercarriage for transport of a feeding device in the before-mentioned configuration, which will enable speedy exchange of the supply-container and by a single person, in the easiest way possible. The feeding device must be unlocked from the bearer frame without difficulty and must have the ability to be set in different operational settings, the bearer frame must show a simple construction and manufactured efficiently.

According to the invention, this is obtained by providing the supporting frame with two laterally mounted panels, wherein support or guiding slots are mounted opposite of each other or a guiding motion link is integrated and whereby the driving engine, a dedicated gearing mechanism, and/or the feeding pump of the feeding device, is provided with at least two guiding bolts which hook into the support shaft of the panel.

The functionality lies in providing the supporting slot with notches, to enable the guiding bolts to direct the feeding device in different angles, and to synchronize the distance between the guiding bolts and the corresponding recessed notches in the panel and which are then provided in different height settings as well. The panels of the supporting frame will, furthermore, be provided with at least one transport position of the feeding device and one mounting position of the corresponding notch of the feeding pump.

The guiding bolts must consist of a rod with sliding bushes, which hook into the supporting slot, integrated in the panel and on the outside of the panel be provided with a end stop.

The supporting frame can be constructed of two solid bars attached to each other with lateral distance, which are cranked in z-shape and are found in the lower part of the undercarriage expanding to the outside and at the lower part of the bar with other bars pointing out to ensure a solid and secure stands. The carrying wheels are mounted on the frame in such a way that the carrying panel runs across the stands surface of the horizontal bar of the supporting frame is slightly recessed in height.

The panels must be attached on the inside of the vertical bar or the supporting frame.

If an undercarriage is constructed according to this invention, then it not only ensures a secure support of the feeding device when pouring the medium in the supply container, but also more efficient handling of the container when exchanging the empty container with a filled container. The undercarriage which supports the feeding device will be supported during operations across the horizontal bars over large panels, but still the feeding device will be secured inside the panels of the supporting frame and during the exchange of the containers it can be easily turned around, enabling exchange by only one person in a short amount of time.

Maintenance costs, especially because of the simple operation, are low, since the undercarriage can be constructed of half-fabricates and is easy to assemble. In this way a small mobile installation is created with single components which are easy to handle and transported by one person and which also allows further attachments on the feeding device, so processing the media will remain easy to perform.

With a simple arrangement, multi-functional deployment is possible with the proposed modifications of the undercarriage and the feeding setup.

The drawing depicts an example of the realization of an undercarriage for transporting a feeding device according to the invention and which shows the different components, as follows:

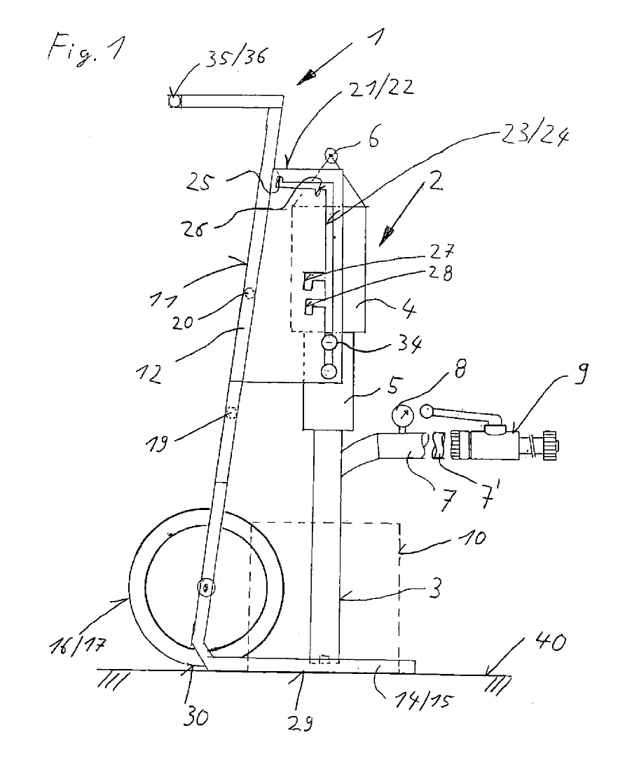

FIG. 1 The undercarriage holding the feeding device, in side view

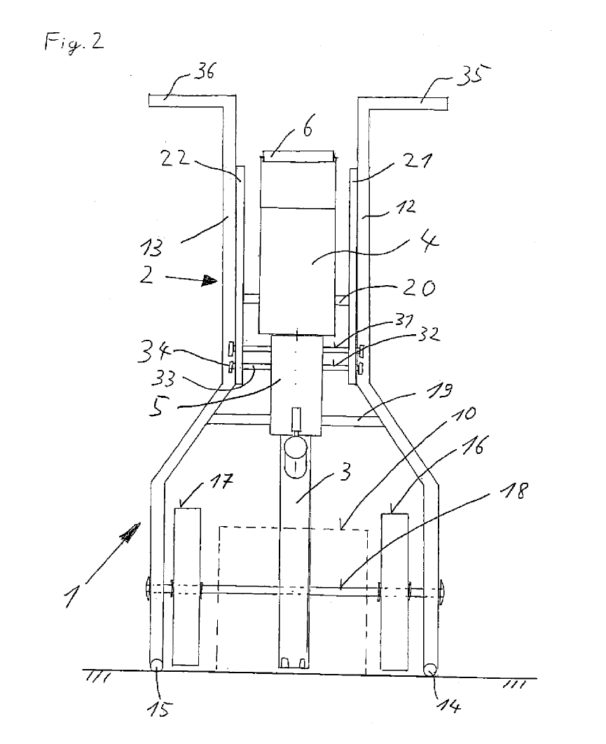

FIG. 2 The undercarriage holding the feeding device as in FIG. 1, in front view

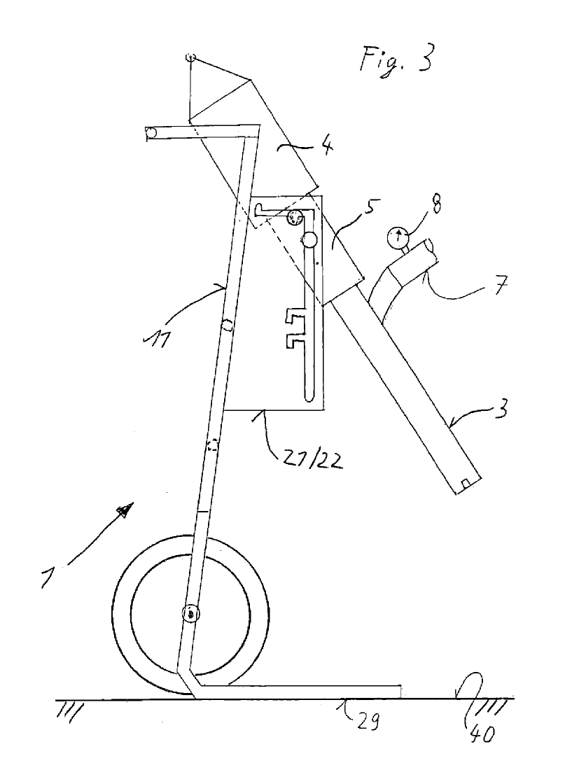

FIG. 3 The undercarriage holding the feeding device as in FIG. 1, in transport setting; e.g. during the exchange of the supply container

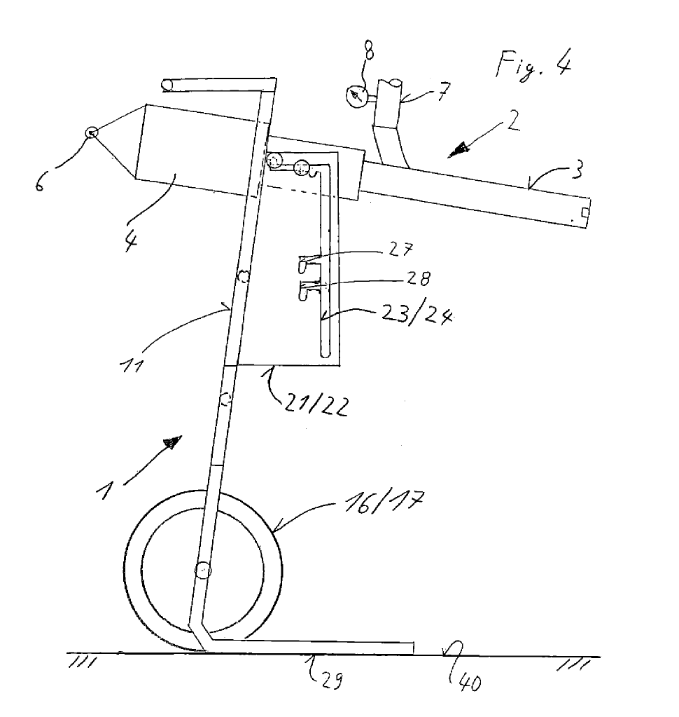

FIG. 4 The undercarriage holding the feeding device as in FIG. 1, in construction setting and

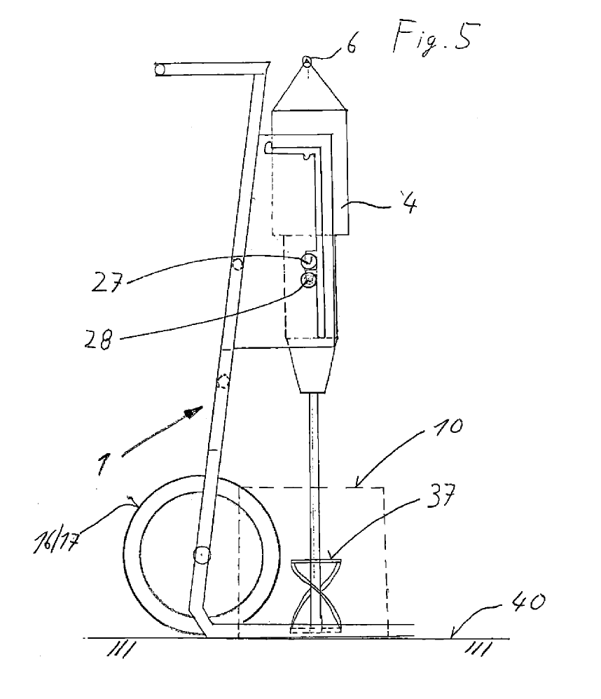

FIG. 5 The undercarriage as in FIGS. 1 and 2 with a mixer provided with a driving unit.

The undercarriage (1) depicted in FIG. 1 to 5 is used to transport a feeding device (2), which consists of a feeding pump (3) equipped as screw pump, configured with a driving engine (4) with remote control and a gearing unit (5), which is intended to feed liquid media, like e.g. mortar from a supply container (10) through a hose (7) with a spraying device (9) attached. The media in the supply container (10), depending on the length of the hose (7), which can be attached to a manometer (8) provided with a connection piece (7), can also be sprayed on a larger (surface) area with a spraying device (9), for instance as spray-plaster on walls.

The undercarriage (1) is depicted as supporting frame (11), consisting of two vertical diverging bars (12 and 13) with two horizontally protruding bars (14 and 15) at the base.

The lower part of bars 12 and 13 are z-shaped falling outward, and provided with carrying wheels pivoting on an axis (18); besides that, the top-end of bars 12 and 13 are shaped as grips 35 and 36 and are connected with each other by cross members 19 and 20 to improve the overall stability.

For structural support of the feeding device (2), panels 21 and 22 are mounted on the inside of bars 12 and 13, with integrated angular support slots 23 and 24 opposing each other diametrical. On both sides of the gearing unit (5) two protruding guiding bolts (31 and 32) are attached, which hook into guiding shaft 23, resp. 24. Guiding bolts 31 and 32 consist of a rod (33) and an end stop (34), e.g. in the shape of a disc, resting against the outside of surface 21, resp. 22. This ensures secure and centered positioning of the feeding device (2) in the supporting frame (11).

To position the feeding device (2) in the different settings, as shown in FIGS. 1, 3 and 4, the supporting slots 23 and 24 are provided with recessed notches (25 and 26), cradling the guiding bolts (31). According to FIGS. 1 and 2 the guiding bolts (32) rest on slots 23 and 24, the feeding pump (3) is submerged in a supply container (10), placed on a subsurface (40), enabling the processed material to be fed to the spraying device (9).

In the setting according to FIG. 3, the guiding bolts (31) cradle in notch 26 of panels 21 and 22. The feeding device (2) is placed in a skewed position, enabling the transport of the feeding device (2) by the undercarriage (1) or to simply exchange the supply container (10). Positioning the feeding device (2) in this setting only requires lifting the grips attached to driving motor (4) and positioning the guiding bolts 31 into notch 26.

If, on the other hand,—as shown in FIG. 4—guiding bolts 31 are positioned in notch 25, then the feeding device (2) will assume an almost horizontal position, in which e.g. repairs on the feeding pump (3) are easily performed.

According to FIG. 5, panels 21 and 22 are provided with the other notches 27 and 28, enabling guiding bolts 31 and 32 to be cradled. In stead of the feeding pump (5) a mixer (37) is placed on the gearing unit (5) to mix the media to be processed in the supply container (10). It is also possible to incorporate several notches 27, 28 in different heights onto panels 21 and 22, to be able to position the feeding device (2) in various heights. This might possibly be of an advantage for differently shaped supply containers.

By continuing to support guiding bolts 31 and 32 in supporting slots 23 and 24, we can ensure that the feeding device (2) is always secured by the supporting shaft, resp. by notches 25, 26, 27 and 28. At the same time, the carrying surface (30) of the carrying wheels 16 and 17 are vertically, slightly recessed in height as opposed to the stands surface (29) of rods 14 and 15. To be able to move the undercarriage, we can tip the supporting frame (11) in such a way that the carrying surface (30) of the carrying wheels (16 and 17) is resting on the subsurface (40), ensuring yet a more secure position of the feeding device (2).

1. An Undercarriage (1) for transportation including a driving motor (4) and a feeding pump (3) by which a device (2) is created for feeding and/or process fluid media, such as mortar, cement mixtures, or the like; the feeding pump (3) incorporated into a supply-container (10) designed to hold the medium which is to be processed constructed of a plurality of L-shaped hollow sections (12, 13, 14 and 15) and provided with a supporting frame (11) on carrying wheels (16 and 17)
characterized by
the fact that the supporting frame (11) carrying the feeding device (2), is equipped with two laterally mounted panels (21 and 22), wherein diametric mounted supporting slots (23 and 24) or a guiding motion link is integrated and wherein the driving engine (4), a dedicated gearing mechanism (5), and/or the feeding pump (3) of the feeding device (2), is provided with at least two guiding bolts (31 and 32) which hook into the support shaft (23,24) of the panels (21 and 22).

2. The Undercarriage of claim 1,
characterized by
the fact that the supporting slots (23 and 24) are provided with first notches (25 and 26), to enable the guiding bolts (31 and 32) to direct the feeding device (2) in different angles.

3. The Undercarriage of claim 1
characterized by
the fact that the distance between the guiding bolts (31 and 32) attached to the feeding device (2) corresponds with the distance between a pair of recesses (27 and 28) in the panels (21 and 22).

4. The Undercarriage of claim 3
characterized by
the fact that the panels (21 and 22) of the supporting frame (11) are provided with second notches (27 and 28) of different height settings.

5. The Undercarriage of claim 4
characterized by
the fact that the panels (21 and 22) of the supporting frame (11) are provided with at least one transport setting of the feeding device (2) and one mounting position of the corresponding first notches (26, 25) of the feeding pump (3).

6. The Undercarriage of claim 1
characterized by
The fact that the guiding bolts (31 and 32) include a rod (33), which hooks into the supporting slots (23 and 24), integrated in the panels (21 and 22) and on the outside of the panel is provided with an end stop (34).

7. The Undercarriage of claim 1
characterized by
the fact that supporting frame (11), includes two vertical diverging bars (12 and 13) which are z-shaped pointing outward with two horizontally protruding bars (14 and 15) at a lower part of bars (12 and 13) at a base of the supporting frame (11).

8. The Undercarriage of claim 7
characterized by
the fact that the carrying wheels (16 and 17) are mounted on the frame (11) such that a carrying surface (30) runs across the stands surface (29) of the horizontal bars (14 and 15) of the supporting frame (11) slightly recessed in height.

10. The Undercarriage of claim 1
characterized by
the fact that the panels (21 and 22) are mounted on the inside of the vertical bars (12 and 13) of the supporting frame (11).
